(19) United States
(12) Patent Application Publication
(10) Pub. No.: US 2022/0233043 A1
(43) Pub. Date: Jul. 28, 2022

(54) METHOD FOR CLEANING WITH A CLEANING ROBOT AND CLEANING ROBOT

(71) Applicant: Vorwerk & Co. Interholding GmbH, Wuppertal (DE)

(72) Inventors: Andrej Mosebach, Unna (DE); Henning Hayn, Hilden (DE)

(21) Appl. No.: 17/576,474

(22) Filed: Jan. 14, 2022

(30) Foreign Application Priority Data
Jan. 28, 2021 (DE) 102021200757

(51) Int. Cl. A47L 9/28; G05D 1/02; A47L 9/00

(52) U.S. Cl. CPC A47L 9/2852; A47L 9/2884; G05D 2201/0215; A47L 9/009; A47L 2201/04; G05D 1/0223

(57) ABSTRACT

A method for cleaning a surface in a private household with a cleaning robot which is provided with at least one sensor for detecting obstacles and for mapping the surroundings and/or performs a cleaning ride according to a route planned on the basis of sensor signals of the sensor. The cleaning robot has wheels for moving in a direction of travel and a cleaning mechanism for cleaning, the wheels and the cleaning mechanism being driven by at least one motor which is supplied with electrical energy by means of at least one battery of the cleaning robot.

### CROSS-REFERENCE TO RELATED APPLICATION

This application claims benefit of priority from German Patent Application No. 102021200757, filed Jan. 28, 2021, the disclosure of which is hereby incorporated in its entirety by reference herein.

### TECHNICAL FIELD

The present invention relates to a method for cleaning a surface of a floor in a private household with a cleaning robot and to a cleaning robot for performing the method.

### BACKGROUND

Cleaning robots such as vacuuming or wiping robots are increasingly used in private households to clean the floor. Due to their light weight and low construction volume, household cleaning robots can also clean floors in confined regions. There are also commercially used cleaning robots for industrial cleaning of, for example, airports and halls, which are provided with very large battery capacity and dirt holding capacity for independent cleaning of corresponding large surfaces. Industrial cleaning robots are therefore correspondingly heavy and have a large construction volume.

In a household there are regions that get dirty very quickly and in many households are cleaned several times a day, while other regions get dirty less quickly and heavily.

### SUMMARY

It is the task of the system of the present disclosure to be able to clean apartments of private households in an improved manner.

A method for cleaning a surface in a private household serves to solve the task with a cleaning robot which is provided with at least one sensor for detecting obstacles and for mapping the surroundings and/or performs a cleaning ride (cleaning run, cleaning journey) according to a route planned on the basis of sensor signals of the sensor. The cleaning robot has wheels for moving in a direction of travel and a cleaning mechanism for cleaning. The wheels and the cleaning mechanism are driven by at least one electric motor which is supplied with electrical energy by means of at least one battery of the cleaning robot. The wheels allow the cleaning robot to be moved without the user having to pull or push the cleaning robot for cleaning. The overall height of the cleaning robot is between 0.12 m and 0.5 m. The cleaning robot can therefore not vacuum under pieces of furniture under which cleaning robots with an overall height of, for example, 10 cm or less can vacuum. The weight W of the cleaning robot is less than 20 kg. The maximum possible operating speed of the cleaning robot is less than 1.50 km/h. This means that the cleaning robot cannot be moved faster than 1.50 km/h in an automated manner during cleaning. An area performance A of the cleaning robot is at least 220 m² at DPU >50%. The area performance is preferably less than 950 m². The area performance A with the unit [m²] describes the size of a surface that can be cleaned after a complete charging of all batteries of the cleaning robot at DPU >50% or with the maximum speed vₘₐₓ at DPU >50%.

### BRIEF DESCRIPTION OF THE DRAWINGS

FIG. 1 is an isometric view of a cleaning robot;

FIG. 2 is a bottom view of the cleaning robot of FIG. 1;

FIG. 3 is a top view of the cleaning robot of FIG. 1 moving in the direction of travel and cleaning a soiled surface.

### DETAILED DESCRIPTION

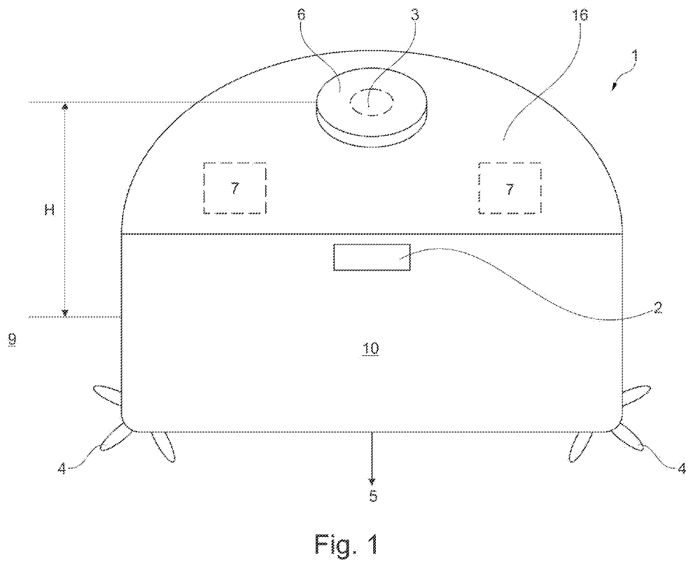

FIG. 1 shows a schematic, isometric view of a cleaning robot 1 from the front. The cleaning robot 1 is provided with a sensor 2 for detecting obstacles and a sensor 3 for mapping the surroundings. A control unit, which is not shown, determines a route based on the sensor signals of the sensor 3, optionally also based on the sensor signals of the sensor 2. The route planned in this way can be followed automatically by the cleaning robot 1. The energy is provided by batteries 7. Preferably, the sensor 2 is a distance sensor that can detect measurement values for determining distances to obstacles, such as pieces of furniture or room boundaries. The sensor 2 is arranged on the front side 10. The sensor 3 is preferably arranged on the upper side 16 of the cleaning robot 1. The sensor 2 and/or the sensor 3 preferably operate contactless, for example with the aid of light, infrared radiation and/or ultrasound. In particular, sensor 3 is configured for 360° distance measurement, for example with an optical triangulation system arranged on a platform rotating about a vertical axis or the like. A disk-shaped cover 6 protects the sensor 3 from above. Optionally, inwardly rotating brushes 4 can be provided to convey coarse dirt under the cleaning robot. The cleaning robot 1 moves in the direction of travel 5, i.e. forwards, over the surface 9 to be cleaned. The cleaning robot 1 has a D shape when viewed from above.

The cleaning robot 1 shown has an overall height H=0.175 m (measured from the surface 9 in the set up state of the cleaning robot 1 to the uppermost outer contour, here in particular in the form of the upper side of the cover 6), a weight W=8.2 kg, a maximum possible operating speed Sₘₐₓ=1.5 km/h and an area performance A=806.4 m² at DPU >50%, which results from the formula A=vₘₐₓ·S_{B}·T·3600 with a maximum speed vₘₐₓ=0.4 m/s at DPU >50%, a cleaning width s_{B}=0.28 m and a maximum running time T=2 h (at vₘₐₓ=0.4 m/s). The cleaning robot shown in FIG. 1 is in particular a vacuuming robot, which was preferably operated on Wilton carpet for measurements.

The cleaning robot 1 shown has a quality characteristic Q=2.365 m²/Wh, which is defined by the formula

$$Q = \frac{A}{E} \cdot R$$

from the area performance A==806.4 m² at DPU >50%, the total energy content E=150 Wh of the at least one battery 7, here in particular two batteries 7, and the cleaning quality R=0.44 as the product of DPU =55%, a fiber pickup F=80% and a coarse material pickup G=100%. The cleaning robot shown has a configuration characteristic K=345 Wh⁻¹, which is defined by the formula

$$K = \frac{H}{V} \cdot Q .$$

The overall height H is 0.175 m and the dust container volume V is 0.0012 m³, or 1.2 L. The value Q is as determined above=2.365 m²/Wh.

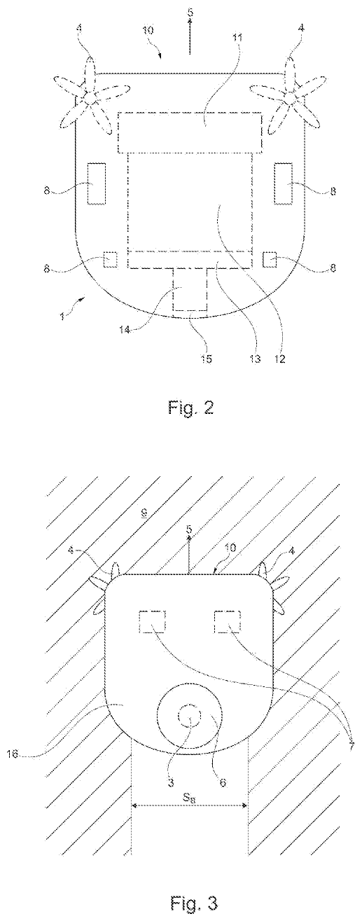

FIG. 2 shows a cleaning robot 1 from below. In particular, four wheels 8 are provided, of which the rear two wheels 8 can be designed as rollers as shown. Optionally, one or two brushes 4 are provided.

In one embodiment, the cleaning robot 1 is a vacuuming robot without a sweeping unit. In this embodiment, the first element 11 of the cleaning mechanism is a nozzle for sucking dirt from the surface 9, the second element 12 of the cleaning mechanism is a dust container, and the third element 13 of the cleaning mechanism is a filter. Downstream of the third element 13 of the cleaning mechanism is the motor 14 and the fan driven by the motor 14, as well as an interface 15 for discharging the sucked and filtered air.

In one embodiment, the cleaning robot 1 is a vacuuming robot with a sweeping unit. In this embodiment, the first element 11 of the cleaning mechanism comprises a sweeping roller driven by the motor 14 and an intake opening. In operation, the sweeping roller with radially protruding bristles dislodges dirt from the surface 9 to be cleaned and moves the dirt by a rotational movement to the suction opening, which extends in particular longitudinally and/or parallel to the axis of rotation of the cleaning roller. The second element 12 of the cleaning mechanism is a dust container and the third element 13 of the cleaning mechanism is a filter. Downstream of the third element 13 of the cleaning mechanism is the motor 14 and the fan driven by the motor 14, as well as an interface 15 for discharging the sucked and filtered air. In particular, the cleaning robot 1 of FIG. 1 is a cleaning robot 1 according to this embodiment.

In one embodiment, the cleaning robot 1 is a sweeping robot. In this embodiment, the brushes 4, which are corner brushes or cup brushes rotating about a vertical axis of rotation, dislodge dirt from the surface 9 and move the dirt to the first element 11 of the cleaning mechanism, which in this embodiment is a dirt pickup device. The brushes 4 are driven by the motor 14. The dirt, picked up by means of the dirt pickup device, passes to the dust container, which is the second element 12 of the cleaning mechanism and stores the dirt. The third element 13 of the cleaning mechanism is the receptacle for the second element 12 for receiving the second element 12 in the cleaning robot 1 in a motion-proof but for the user manually releasable manner. As for all other embodiments, the interface 15 may comprise in particular electrical contacts for charging the at least one battery 7.

In one embodiment, the cleaning robot 1 is a wiping robot. In this embodiment, the first element 11 of the cleaning mechanism is a wiping element. In particular, the first element 11 can be driven by the motor 14 to perform a relative movement relative to the front side 10 of the cleaning robot 1. In particular, the wiping element is a substantially rectangular shaped element made of a fabric or sponge material that is translationally moved and/or vibrated by the motor 14. The wiping element may also have an elongated roller shape with a surface of fabric or sponge material and be rotated by the motor 14. The wiping element, particularly the fabric or sponge material, is designed to absorb and temporarily store water so that the surface 9 can be wet cleaned. The material for absorbing water is preferably a cloth or mob. The wiping element may comprise a holder for the water absorbing material and the water absorbing material. Preferably, the water absorbing material may be manually changed by the user. Optionally, the brushes 4 may also be wiping elements that can then be rotated about a vertical axis from the motor to the center of the cleaning robot 1. In this case, the first element 11 can be a receptacle for the dirt.

In this embodiment, in which the cleaning robot 1 is a wiping robot, the second element 12 of the cleaning mechanism represents a dust container that stores the wet-wiped dust and dirt. The second element 12 may also comprise a further wiping element. In particular, the third element 13 of the cleaning mechanism comprises a tank for cleaning liquid, which is for example in the simplest case water. The interface 15 may serve to fill the tank and/or comprise electrical contacts for charging the at least one battery 7.

In one embodiment, the cleaning robot 1 is a wiping robot in which the first element 11 of the cleaning mechanism comprises a wiping element (as in the preceding embodiment) and a suction opening for sucking up dirt. In this embodiment, the second element 12 of the cleaning mechanism is a dust container and the third element 13 of the cleaning mechanism is a filter. Downstream of the third element 13 of the cleaning mechanism is the motor 14 and the fan driven by the motor 14, as well as an interface 15 for discharging the sucked and filtered air.

In one embodiment of the cleaning robot 1 configured as a wiping robot, the cleaning robot 1 has a larger total energy content E=200 Wh compared to the cleaning robot 1 shown in FIG. 1 in order to achieve the area performance A=806.4 m² at DPU >50%. As vₘₐₓ=0.3 m/s, the maximum speed at DPU >50% is lower in this embodiment. The overall height H was reduced to 16.2 cm. The other parameters of the cleaning robot 1 of this embodiment essentially correspond to the values given above for the cleaning robot 1 shown in FIG. 1. When wiping on a surface to be cleaned, the wiping robot of this embodiment produces a greater frictional resistance than the cleaning robot 1 of FIG. 1. When the cleaning robot 1 of this embodiment is configured as a wiping robot, the quality factor Q=1.33 and the configuration parameter K=180 Wh⁻¹. The cleaning robot 1 configured in this way is therefore also suitable and configured for the application according to the invention.

FIG. 3 illustrates the cleaning width s_{B} when a cleaning robot 1 travels straight ahead in travel direction 5 over a surface 9 to be cleaned that is dirty (as symbolized by the hatching). The cleaning robot 1 optionally has a sensor 3 on the upper side 16, which is protected by a cover 6. In particular, two batteries 7 are provided. When the cleaning robot 1 moves over the surface 9 to be cleaned, brushes 4 move coarse dirt under the cleaning robot 1. When determining the dust pick-up value (DPU), only the width of the suction opening is used as a basis for the cleaning width s_{B} according to IEC-62885. The cleaning width s_{B} is illustrated in FIG. 3 by a strip without hatching behind the cleaning robot 1, which has been cleaned by the cleaning robot 1 with a DPU value of >50% when passing over it.

A cleaning robot in the sense of the present disclosure is a robot that can pick up particles. A cleaning robot can clean a surface without requiring a user during the cleaning process. The cleaning robot may be a vacuuming robot or a wiping robot. A wiping robot has a wiping element, such as a rag, mob, sponge, or cleaning fabric. The wiping element can hold water. A wiping robot may have a fan for sucking dirt and/or be configured such that the wiping element can be moved translationally and/or rotationally relative to the housing of the wiping robot to pick up dirt particles. The wiping element is removably attached to the wiping robot and can be removed and replaced by the user for cleaning. A vacuuming robot can independently clean a surface by vacuuming. The vacuuming robot has a fan through which air can be sucked. The vacuuming robot has a container in which vacuumed particles are collected. The vacuuming robot has at least one filter through which sucked-in air laden with particles is separated from dust. The air thus cleaned is then blown out of the vacuuming robot. If the vacuuming robot cleans a surface substantially by sucking in dirt through a nozzle or suction opening, the cleaning width may correspond to the width of the nozzle or suction opening. Such vacuuming robots can be used, for example, for cleaning laminate floors. For cleaning, for example, carpet or surfaces with carpet and hard floor, a vacuuming robot preferably has a sweeping unit that assists in picking up particles. In one embodiment, even a cleaning robot that cannot vacuum has a sweeping unit. The sweeping unit may be a sweeping roller that is rotatably mounted and driven by the motor during cleaning. In particular, a sweeping roller is provided with protruding bristles, ledges and/or nubs to be able to transport particles into a vacuuming robot. In particular, when a sweeping roller is provided, the cleaning width can also be equated with the width of the sweeping roller for simplicity. Alternatively or additionally, the sweeping unit may comprise one or two corner brushes. A corner brush can rotate about a vertical axis of rotation like a cup brush. A sweeping unit may consist of two corner brushes without a sweeping roller. In such a cleaning mechanism, dirt is brushed under or into the cleaning robot by the corner brushes with or without suction.

As mentioned above, a cleaning robot can be designed for different applications. There are cleaning robots for industrial use that are designed for cleaning large surfaces, for example of an airport or halls, and therefore clean surfaces of 500 m² and more. To achieve this, such industrial cleaning robots are particularly powerful and can be moved especially quickly. Usual maximum possible operating speeds Sₘₐₓ of such industrial cleaning robots are considerably more than 1.50 km/h. A cleaning robot designed for industrial purposes is therefore large and heavy compared to a cleaning robot provided for cleaning private households. With industrial cleaning robots, area performances A of more than 950 m² are possible at DPU >50%, where A=vₘₐₓ S_{B} T 3600. In this, vₘₐₓ=maximum speed in [m/s], i.e. in meters per second, at DPU >50%, s_{B}=cleaning width in [m], i.e. in meters, and T=maximum running time in [h], i.e. in hours, at the maximum speed vₘₐₓ at DPU >50%. The maximum running time T is the operating time that is possible with a full charge of the battery or batteries of the cleaning robot at the maximum speed vₘₐₓ at which the criterion DPU >50% is just fulfilled over the cleaning width. Full charge means that all batteries of the cleaning robot are fully charged at the beginning of a time measurement. DPU means the dust pickup. The measurement can be performed on hard floor, preferably made of untreated laminated layered pine boards, in particular with a thickness of at least 15 mm. Alternatively, the measurement can be made on carpet, preferably Wilton carpet, in particular according to IEC TS 62885-1. A preferred measurement setup for both hard floor and carpet is given in the IEC-62885-7 standard in the version valid at the filing date, in particular for medium debris. This also applies to the other parameters, such as fiber pickup, coarse material pickup, maximum speed at DPU >50% and the corresponding parameters for determining area performance. DPU stands for “dust pick-up rate”. DPU >50% therefore means that the dust pick-up from the surfaces to be cleaned is more than 50%. The cleaning width is the width perpendicular to the direction of travel that the cleaning robot is capable of cleaning when moving forward in the direction of travel during a cleaning ride with DPU >50%.

A cleaning robot for a household should also be able to vacuum under pieces of furniture such as beds and couches. For this reason, a low overall height is aimed for in a cleaning robot of this type. In addition, the diameter of such a cleaning robot, or its maximum extension parallel to the surface to be cleaned, should be relatively small so that it can also drive into narrow spaces in order to be able to clean there. Compared with an industrial cleaning robot, the power is low and the maximum possible operating speed is below 1.50 km/h. One example of such a household cleaning robot is the VR300 of the Vorwerk company, which is already regarded as particularly powerful among household cleaning robots. The area performance A of the VR300 cleaning robot, i.e., at DPU >50%, is 129.6 m². Its maximum possible operating speed is 1.2 km/h. The surfaces is cleaned by the cleaning robot at least twice a day for at least one week, wherein at least one piece of furniture with a clearance height of no more than 10 cm is present on the surfaces to be cleaned.

In a household, there are regions that get dirty very quickly. For example, regions around a dining table often get dirty several times a day. Frequently used walkways within an apartment can also get dirty relatively quickly. If such regions are to be kept clean, then it may be necessary to clean them several times a day. Other regions within an apartment at least do not immediately get dirty. This typically involves regions underneath beds or couches with low clearance height. Particles and dust do not enter such regions directly, but are transported into them, for example, by air movements from laterally adjacent surfaces.

On the surface to be cleaned there is at least one piece of furniture with a clearance height of maximum 10 cm. A cleaning robot can therefore only remove dust under the piece of furniture if the overall height of the cleaning robot is less than 10 cm. The overall height of more than 0.12 m ensures that the cleaning robot according to the present disclosure does not clean regions into which dust and particles do not directly enter.

Thus, such regions cannot and should not be cleaned by the cleaning robot according to the present disclosure.

A maximum possible operating speed of the cleaning robot of less than 1.50 km/h ensures that the cleaning robot cannot be moved at an excessively high speed during cleaning. An excessively high speed could damage furniture in private households. This is avoided by limiting the speed. The stopping distance can thus be reduced and safety can be increased. This is particularly important in the present case because the mass of the cleaning robot is comparatively large compared to conventional household cleaning robots.

The area performance is at least 220 m² with DPU of 50%. Despite the relatively low speed of the cleaning robot during cleaning, a comparatively large surfaces can still be cleaned in a short time compared with the area performance of a conventional cleaning robot for private households. It is true that a relatively large width of the sweeping roller is typically required in order to achieve the area performance despite the relatively low speed. Therefore, a cleaning robot according to the present disclosure is basically wider than usual cleaning robots used in private households. Therefore, principally, not only regions under pieces of furniture with a low clearance height are excluded from cleaning, but also narrow spaces that typically do not get dirty directly and therefore hardly get dirty.

Since the surfaces to be cleaned is cleaned at least twice a day by the cleaning robot for at least one week, the regions that get dirty easily and repeatedly are cleaned with high frequency. Due to the design of the cleaning robot, regions that hardly get dirty and especially not when adjacent regions, i.e. surfaces adjacent to it, are cleaned with high frequency are necessarily excluded.

It is thus achieved by the systems and methods of the present disclosure that cleaning is carried out frequently where it is required and regions that are not required are excluded without having to program this. Superfluous cleaning is thus avoided in order to save time. Disturbances caused by frequent cleaning are thus minimized.

In the case of the cleaning robot according to the present disclosure, it is therefore important that it achieves a large area performance in order to cause as little disruption as possible, since according to the present disclosure it is generally used at least twice a day for a longer period of time. On the other hand, it is not important for such a cleaning robot to have complicated navigation qualities, for example for reliably cleaning narrow spaces. The design of the cleaning robot generally minimizes time-consuming maneuvering due to narrow spaces.

The overall height is preferably no more than 0.5 m to allow vacuuming under dining tables. Particularly preferably, the overall height is no more than 0.4 m, so that vacuuming is also possible under chairs of normal height.

The present disclosure also relates to a cleaning robot for performing the method. The features, embodiments and definitions described above also apply to this aspect of the present disclosure. The cleaning robot is provided with at least one sensor for detecting obstacles and mapping the surroundings and/or configured for performing a cleaning ride according to a route planned based on sensor signals of the sensor. Sensor signals can be analog or digital signals. Preferably, the sensor delivers analog measurement values. A signal processing unit may be provided to process the analog measurement values and provide digital sensor signals. The sensor signals include information about a distance, an obstacle and/or a property of the surroundings, in particular a geometric property. Such a cleaning robot is thus a so-called “intelligent” cleaning robot with a mapping system. In contrast to this, there is also another class of cleaning robots which, described in simplified terms, essentially always travel straight ahead and only change direction in the event of a collision with an obstacle in order to travel, in a way at random, over a surface to be cleaned.

The cleaning robot has wheels for moving in a direction of travel and a cleaning mechanism for cleaning. The wheels and the cleaning mechanism are driven by at least one motor, which is supplied with electrical energy by means of at least one battery of the cleaning robot. If the cleaning robot is a vacuuming robot, it comprises a fan through which air can be sucked, a container in which vacuumed particles are collected, and at least one filter through which sucked-in air laden with particles is separated from dust. The vacuuming robot may comprise a sweeping unit driven by the motor, which assists in the collection of particles as a component of the cleaning mechanism. Preferably, the sweeping unit in a vacuuming robot is a sweeping roller. The sweeping roller rotates during a cleaning operation. Thus, particles can be collected on the surface to be cleaned and transported into the vacuuming robot. The cleaning robot may be a sweeping robot that cannot vacuum. The cleaning mechanism then comprises a sweeping unit that can be moved by the motor and has one or more sweeping brushes, such as corner brushes, with which dirt particles are captured on the surface to be cleaned (without being sucked in) and transported into the cleaning robot. The cleaning robot may be a wiping robot in which the cleaning mechanism comprises a wiping element for cleaning by wet wiping.

The overall height of the cleaning robot is 0.12 m to 0.5 m. The weight W of the cleaning robot is less than 20 kg. The maximum possible operating speed of the cleaning robot is less than 1.50 km/h. Preferably, the maximum possible operating speed is achieved by controlled throttling of the speed so that the same maximum possible operating speed can still be realized in operation on floors with higher frictional resistance, e.g. carpet floors, as on floors with lower frictional resistance, e.g. hard floors.

The area performance A at DPU >50% of the cleaning robot is 220 m² to 950 m². The area performance is A=vₘₐₓ·s_{B}·T·3600, where vₘₐₓ=maximum speed in [m/s] at DPU >50%, s_{B}=cleaning width of the cleaning robot in [m] and T=maximum running time in [h] at the maximum speed vₘₐₓ at DPU >50%. The cleaning width is the width transverse to the direction of travel that the cleaning robot is capable of cleaning during a forward movement in the direction of travel during a cleaning ride.

The special feature of the cleaning robot is that it is optimized for the application that regions in a private household which get dirty easily are cleaned with high frequency. Its design ensures that regions that do not get dirty easily are generally left out. In order for the cleaning robot to be able to vacuum at high frequency, its area performance is large compared to area performance of common cleaning robots used for household applications. The cleaning robot according to the present disclosure differs from conventional industrial cleaning robots primarily in its relatively low maximum possible operating speed.

In one embodiment, the maximum energy content per battery is 100 Wh. In one embodiment, the total energy content of the one battery or the plurality of batteries is at least 100 Wh and/or at most 200 Wh in total. The energy content thus relates to the sum of the batteries if several batteries are provided. This selection has proven to be particularly suitable for using the cleaning robot in the manner described. The energy content of such a battery is significantly greater than the energy content of a battery for a cleaning robot that is conventionally used in private households. On the other hand, the energy content of the battery is significantly lower than the energy content of a battery such as is regularly provided for an industrial cleaning robot.

In one embodiment, the cleaning robot is supplied with electrical energy by exactly two batteries. By using exactly two batteries, a suitable energy content can be provided in a particularly user-friendly manner. A battery is a battery that can be recharged. A battery is a construction unit that can be arranged in the cleaning robot spatially separated from another battery. Preferably, the battery can be manually removed from the cleaning robot by the user for recharging and then reinserted. Alternatively, a permanently installed battery is also possible, which is charged, for example, via a cable or electrical contacts for connection to a station. A battery can also be referred to as a battery pack. Providing exactly two or even more than two battery packs has the advantage that the weight of the batteries can be suitably distributed.

The battery or batteries are preferably configured to be fully recharged within three hours.

This also ensures that the cleaning robot can clean a surface of a floor in a private household several times a day.

In one embodiment, the weight W of the cleaning robot is more than 5 kg, preferably at least 6 kg, and/or at most 18 kg. The desired properties can be provided by this. In particular, the weight W of the cleaning robot is not more than 13 kg. Tests have shown that a cleaning robot weighing 8 kg, for example, achieves the desired properties in a particularly optimum manner. The weight of the cleaning robot thus exceeds the weight of a conventional cleaning robot used for vacuum cleaning in private households. In particular, the weight can be influenced by the selection of the batteries for providing the desired energy content.

In one embodiment, the filter area of a cleaning robot configured in particular as a vacuuming robot is at least 329 cm², particularly preferably more than 450 cm². The cleaning robot according to the present disclosure takes advantage of the fact that it is relatively large compared to conventional cleaning robots for private households and can therefore also provide space for a large filter area. Large filter areas are associated with the advantage that flow losses of air can be kept low. For example, a maximum speed and a maximum running time T for achieving an area performance of between at least 300 m² and/or at most 950 m² can be achieved particularly reliably at DPU >50% using the filter area specified above. The maximum running time T can also be determined by calculation instead of by measurement by means of the total energy content (or a capacity value) of the battery or batteries and the power consumption of the cleaning robot for cleaning a surface at DPU >50%.

Filter area means the surface of the filter or filters provided for filtering the sucked-in dirty air. Therefore, the filter area does not include, for example, a filter frame made of plastic or cardboard, but only a filter material, for example, a filter membrane of the filter. The filter material is such that it effectively and efficiently filters dirt from air flowing through the filter material. Here, the filter area refers in particular to the filter, i.e., the filter component that can be changed or cleaned by the user, such as a dust bag or dust collector. The filter area refers to the air passage area through one or more filtering materials of the filter. For example, if a filter component for replacement has a structure comprising a double membrane or multiple filter membrane layers in series, all extending over a common air passage area, that filter has the same filter area as a single membrane filter having the same air passage area. For a filter that has a pleated shape, the filter area refers to the unfolded surface. In particular, a HEPA filter material is used, preferably certified according to the EN 1822 standard. In particular, the filter material includes or is fleece. Alternatively or complementarily, the filter or filter material is or includes a porous fluoroplastic film, preferably a PTFE membrane, for air filters. Alternatively or complementarily, the filter or filter material is or includes spunbounded non-woven fabric, preferably one or two layers each having a weight of at least 5 g/m² and/or at most 100 g/m². Preferably, the thickness of the filter material is at least 0.1 mm and/or at most 1 mm. Preferably, the filter material is pleated in a zigzag shape and/or fixed in a preferably rectangular frame. Alternatively or complementarily, a multi-layer arrangement is provided, preferably having three or exactly three layers. In one embodiment, the separation efficiency of the filter (on the filter area) is at least 80%, preferably at least 90%, particularly preferably approximately or exactly 99.97%, especially for a particle size of 0.3 to 0.5 μm. In one embodiment, a structure comprising a layer of spunbounded non-woven fabric preferably having a specific weight of 15 g/m² and/or a layer of a porous fluoroplastic film, preferably a PTFE membrane and/or a layer of a bonded nonwoven fabric preferably having a specific weight of 70 g/m² is provided, in particular of three layers in exactly the order previously mentioned. In one embodiment, a filter is provided having a pressure drop (at the filter area) of at least 130 Pa and/or at most 220 Pa, particularly preferably a pressure drop of approximately or exactly 170 Pa. Preferably, a thickness of one layer of the filter material is 0.32 mm or the total thickness of a multilayer filter material is 0.32 mm. Preferably, the filter material or the filter area has a weight of 85 g m².

The filter area of the cleaning robot is preferably not more than 900 cm², particularly preferably not more than 700 cm². Such a filter area is smaller than a filter area that may be provided in an industrial cleaning robot. This avoids the cleaning robot having to be built excessively large, which would be unfavorable for its intended use in private households.

In one embodiment, the maximum fan power of a cleaning robot configured in particular as a vacuuming robot is at least 25 W. It has proved expedient to select a fan power of at least 25 W. A maximum fan power of 27 watts, for example, is also provided for other cleaning robots used in private households. The fan power of the cleaning robot according to the present disclosure can therefore be comparable to the fan power of a cleaning robot used in a private household. The reason is that the cleaning robot according to the present disclosure is also to be used in a private household and consequently comparable requirements are to be met with regard to particle pickup. Furthermore, the battery capacity that would be needed for a higher fan power is used in the present case for a cleaning range which is longer in time or to reduce the battery capacity and thus the weight, in order to support the effect according to the present disclosure particularly effectively. The maximum fan power is preferably no more than 30 W. This means that the fan power is of the same order of magnitude as that provided for other cleaning robots used in private households. The fan power for industrial cleaning robots can be significantly higher, as other requirements may have to be met here.

In one embodiment, the construction volume BV of the cleaning robot is more than 10 L (liters), preferably at least 11 L, and preferably at least 15 L. This means that the construction volume is greater than the construction volume of conventional cleaning robots used in private households. The construction volume means the volume determined from the external dimensions. The cleaning robot of the present disclosure is not too small, so that it ideally does not spend time cleaning regions that need to be cleaned only infrequently. The construction volume of the cleaning robot is preferably BV <40 L, particularly preferably BV≤30 L, since the cleaning robot according to the present disclosure should also not be built too large for its intended use in a private household. The construction volume of an industrial cleaning robot can be significantly larger than 40 L.

The volume flow at the suction nozzle of the cleaning robot can be 10 to 14 l/s (liters per second). This is the volume flow that is usual for a cleaning robot for private households.

The suction nozzle can be a suction opening of the cleaning robot, through which the dirt is sucked up from the floor and transported to the filter. The volume flow rate has been selected as mentioned because the cleaning robot is intended for use in private households and is therefore intended to remove particles of the kind that usually occur in private households in the form of dirt. In the case of an industrial cleaning robot, the volume flow rate can be significantly higher, since other requirements may have to be taken into account in industrial use, which may require larger volume flow rates at the nozzle.

The volume flow of the fan can be at least 20 I/s and/or up to a maximum of 40 I/s or a maximum of 60 I/s (liters per second). For the aforementioned reasons, this volume flow corresponds to the volume flow that is usual for cleaning robots that are to be used in private households. Larger volume flows may be provided for cleaning robots used in industry due to other requirements.

In one embodiment, the cleaning width is at least 25 cm, preferably at least 28 cm, and/or at most 35 cm, preferably at most 32 cm. If the cleaning robot comprises a sweeping roller, the sweeping roller has a width of at least 25 cm, preferably at least 28 cm, and/or at most 35 cm, preferably at most 32 cm. The range between 25 cm and 35 cm corresponds to the range between usual cleaning widths of cleaning robots used in private households. Common sweeping rollers of vacuum robots used in the industrial sector often have a width of at least 32 cm. It is taken into account that surface areas are to be cleaned in one day that are between the surface areas that are conventionally to be cleaned daily by a cleaning robot for private households and the surface areas that are conventionally to be cleaned daily by an industrial cleaning robot.

In one embodiment, the maximum speed vₘₐₓ is at least 0.3 m/s at DPU >50%. This enables particularly efficient cleaning of remote areas to which dirt is usually transported by air currents. The slower the cleaning robot moves in the direction of travel, the greater the DPU value, and the faster the cleaning robot moves in the direction of travel, the lower the DPU value accordingly. The maximum speed at DPU >50% is exactly the speed at which the cleaning robot just achieves at least DPU >50%. A cleaning robot that is conventionally used in private households can generally only achieve cleaning with DPU >50% at slower speeds of 0.2 m/s, for example. In particular, the maximum speed vₘₐₓ is approximately or at most 0.415 m/s at DPU >50%.

In one embodiment, the area performance A of the cleaning robot is preferably at least 500 m², particularly preferably at least 600 m² with DPU >50%. An upper limit for this application is an area performance of no more than 900 m², since in practice there is basically no need for even higher area performances. The area performance of the cleaning robot according to the present disclosure with a value from 500 m² is thus significantly higher than the area performance of conventional cleaning robots used in private households. With an upper limit of 900 m², the area performance of the cleaning robot according to the present disclosure does not come close to the area performance that industrial vacuum robots can usually achieve.

In one embodiment, the maximum dust pickup DPU is less than 80%, preferably less than 70%. Since the cleaning robot according to the present disclosure is provided for frequent use, the problem of having to remove dirt that has been trodden in does not exist. The maximum dust pickup can therefore be limited to 80% or 70% in order to keep the technical effort for the cleaning robot according to the present disclosure within reasonable limits. The maximum dust pickup DPU is measured in particular according to the IEC 62885 standard. In one embodiment, which is technically more complex, the maximum dust pickup is at most 99%.

The fiber pickup is preferably at least 60% (category 3 of 5—Good), preferably at least 70%, particularly preferably 80% (category 4 of 5—Very Good). A minimum value of 60% contributes to reliable area performance. In particular, the fiber pickup is at most 90%. A limitation to 90% allows a simple construction and lower weight of the cleaning robot. In one embodiment, which is technically more complex, the fiber pickup is at most 100% (category 5 out of 5—Excellent). The fiber pickup is measured on hard floors or—especially if the cleaning robot is a vacuuming robot—on carpet (Wilton BIC3) according to the IEC 62885 standard (for example, based on a classification in categories 1 to 5).

Preferably, the coarse material pickup is 100%. Coarse particles very often contribute to daily soiling. It is therefore advantageous if the cleaning robot is designed to pick up 100% of such particles. A measurement of the coarse material pickup is preferably carried out on a hard-floor surface, in particular according to IEC 62885-2:2016. Alternatively—in particular if the cleaning robot is a vacuuming robot—carpet according to standard IEC 62885 can preferably be used as a ground for the measurement, preferably the standard test carpet BIC3 (Wilton carpet, in particular according to IEC 62885-2:2016, Annex C.1—Wilton Carpet).

The maximum running time at DPU >50% is greater than 60 minutes, preferably at least 80 minutes, particularly preferably more than 100 minutes. At this value, the suction robot according to the present disclosure can be used several times a day without any problems. It was recognized that a value of more than 180 minutes is not necessary for the intended use and to achieve the effect described above, but at the same time would increase the weight due to the additional energy required for this purpose by batteries.

In one embodiment, therefore, the maximum running time at DPU >50% is limited to less than 180 minutes.

In one embodiment, which may be a separate aspect of the present disclosure, a quality factor Q of the cleaning robot is at least 1.3 m²/Wh, preferably more than 1.8 m²/Wh, particularly preferably more than 2 m²/Wh and/or at most 4.7 m²/Wh. The advantage of the present disclosure described at the beginning for particularly efficient cleaning in the household, even of remote locations into which dirt is usually transported by air currents, can thus be implemented particularly easily. The quality factor enables the cleaning robot to be configured accordingly, taking into account the large number of input variables whose correlations with the effect described above have been identified in the course of the present disclosure.

The following formula is used to determine the quality factor:

$$Q = \frac{A}{E} \cdot R$$

The area performance A has already been defined above and the calculation method has been explained. The cleaning quality R can be determined from the measurement quantities for the dust pick-up DPU (dust pick-up rate) in [%], the fiber pickup F in [%] (for example, based on a classification into categories 1 to 5) and the coarse material pickup G in [%], which are common in vacuum cleaner development and defined in the IEC-62885-7 standard, as follows:

$$R = \frac{D P U}{100 \%} \cdot \frac{F}{100 \%} \cdot \frac{G}{100 \%}$$

The energy content E with the unit Wh (watt-hours) is the total energy content of the at least one battery of the cleaning robot after a complete charge. This total energy content is sufficient to provide the area performance A, i.e., to clean the surface with the size A at DPU >50%.

For comparison, the Vorwerk VR200 cleaning robot achieves a quality factor of 0.76 m²/Wh and its successor VR300 a quality factor of 0.91 m²/Wh. The cleaning robot Neato D7 achieves a configuration characteristic Q of 0.75 m²/Wh. In particular, Q is less than 4 m²/Wh. A higher Q value would require a highly complex design and, as a result, an excessively high manufacturing effort. The maximum dust pickup DPU is 49% for the VR 300, 41% for the VR 200, and 30% for the Neato D7. These and the following values were determined on Wilton carpet. Coarse material pickup G was 99% for the VR 300 and VR 200 and 91% for the Neato D7. The maximum speed at DPU >50% is 0.2 m/s for the VR 300, VR 200 and Neato D7 and the fiber pickup is 80% for all three units. The cleaning width essentially corresponded to the width of the sweeping roller, i.e. 0.24 m for the VR 300 and VR 200 and 0.27 m for the Neato D7. Due to the battery capacity of 74 Wh for the VR200 and VR300 and 51 Wh for the Neato D7, the cleaning time or maximum running time at DPU >50% was, 1 hour for the VR200 and VR300 and 0.9 hours for the Neato D7.

In one embodiment, which may be a separate aspect of the present disclosure, a configuration characteristic K of the cleaning robot is at least 180 Wh⁻¹, preferably K >200 Wh⁻¹, more preferably K >220 Wh⁻¹, most preferably K >240 Wh⁻¹. Preferably, K is less than 935 Wh⁻¹ because a higher K value would lead to an excessively high manufacturing effort as a result of the complex structure of the cleaning robot required for this purpose.

The configuration characteristic K is defined as follows:

$$K = \frac{H \cdot A}{V \cdot E} \cdot R$$

The configuration characteristic therefore corresponds to

$$K = \frac{H}{V} \cdot Q$$

with the quality characteristic explained above. The variables A, E and R are therefore defined analogously to the quality characteristic.

The overall height H describes the overall height of the cleaning robot in [m], i.e. meters. The overall height is the clearance height of the cleaning robot during operation, which indicates the clearance height under objects such as pieces of furniture that is still possible for the cleaning robot to pass without play. The dust container volume V is the container volume of the container in which the vacuumed particles are collected, with the unit [m³], i.e. cubic meters. A dust container may be a dust bag. In particular, the dust container volume V is at least 0.0009 m³ and/or at most 0.0025 m³.

The higher the configuration characteristic, the more suitable the cleaning robot is for the intended use. Common cleaning robots for private households and for industrial use have significantly lower configuration characteristics and are therefore less suitable. The VR200 household cleaning robot, for example, has a value of K=86 Wh⁻¹ and the VR300 a value of K=103 Wh⁻¹. The overall height of the VR200 and VR300 is 8 cm with a weight W of 5 kg. The area performance A of the VR200 and VR300, i.e., at DPU >50%, is 129.6 m² and the dust container volume is 0.00053 m³, i.e., 0.53 L.

The preceding embodiment using quality factor Q and the embodiment using configuration characteristic K may each be separate aspects of the present disclosure, which may relate to a cleaning robot for performing the method according to the aspect of the present disclosure described at the beginning. Both aspects of the present disclosure specify a cleaning robot by means of a range of parameters for the quality factor Q and the configuration characteristic K, respectively. Thus, guidance is provided which enables to match the relevant device characteristics to each other in an optimal relationship for the determination of use as explained above.

If a cleaning robot is designed such that the specified minimum value for the quality factor Q and/or the configuration characteristic K is achieved, this cleaning robot can be used in a particularly resource-efficient manner to keep an apartment and its floor area (as described in connection with the aspect of the method according to the present disclosure described at the beginning) always in a condition cleaned of dirt. The features, embodiments and definitions described in connection with the previously described aspects of the present disclosure can therefore also be applied to these aspects of the present disclosure with the quality factor Q or the configuration characteristic K, respectively. Also in these aspects of the present disclosure, the cleaning robot is provided with at least one sensor for detecting obstacles and for mapping the surroundings and/or configured for performing a cleaning ride according to a route planned on the basis of sensor signals of the sensor. The cleaning robot has wheels for moving in a direction of travel and a cleaning mechanism for cleaning. The wheels and the cleaning mechanism are driven by at least one motor that is supplied with electrical power by means of at least one battery of the cleaning robot. If the cleaning robot is a vacuuming robot, it comprises a fan through which air can be sucked, a container in which vacuumed particles are collected, and at least one filter through which sucked-in air laden with particles is separated from dust. The vacuuming robot may comprise a sweeping unit driven by the motor, which assists in the collection of particles as a component of the cleaning mechanism. Preferably, the sweeping unit in a vacuuming robot is a sweeping roller. The sweeping roller rotates during a cleaning operation. Thus, particles can be collected on the surface to be cleaned and transported into the vacuuming robot. In particular, if a sweeping roller is provided, the cleaning width can also be equated with the width of the sweeping roller for simplicity. The cleaning robot may be a sweeping robot that cannot vacuum. The cleaning mechanism then comprises a sweeping unit that can be moved by the motor and has one or more sweeping brushes, such as corner brushes, with which dirt particles are captured on the surface to be cleaned (without being sucked in) and transported into the cleaning robot. The cleaning robot may be a wiping robot in which the cleaning mechanism comprises a wiping element for cleaning by wet wiping. The cleaning robot has a weight W of less than 20 kg and a maximum possible operating speed of less than 1.50 km/h.

The preferred upper limit for the Q-value of Q=4.7 m²/Wh mentioned above, as well as the preferred upper limit for the K-value of K=935 Wh⁻¹ mentioned above, is measured for example for a cleaning robot designed as a vacuuming robot preferably on Wilton carpet with the parameters of a cleaning width of 32 cm, which may correspond to the width of the brush roller, vₘₐₓ=0.41 m/s, A=945 m², DP =99%, F=100%, G=100% and T=2 h, as well as a dust container volume V=0.0025 m³, a total energy content E=200 Wh and an overall height of 0.5 m. Such a cleaning robot can also have, for example, a construction volume BV=38 L, a filter area V=900 cm² and/or a maximum possible operating speed of Sₘₐₓ=1.5 km/h.

In one embodiment, the cleaning robot has a D-shape when viewed from above. The D-shape enables the system of the present disclosure to be implemented in a particularly effective manner. Preferably, the cleaning robot has a straight front contour at the front, i.e. in the direction of travel, and/or a curved or c-shaped outer contour at the rear.

In one embodiment, the cleaning robot comprises an interface for wireless data transmission. This enables transmitting sensor signals of the sensor to an external computer unit and/or receiving data for the cleaning ride from an external computer unit to the cleaning robot. For example, a map of the surroundings or a route for a cleaning ride based on the sensor signals of the sensor can be displayed to a user on a smartphone in this way. For example, a mapping and/or creation of a map of the surroundings can be performed on a server computer. In particular, the cleaning robot can follow a route for the cleaning ride calculated by the server computer. In particular, the cleaning robot can independently detect an obstacle by the sensor and react to it by changing the route. In one embodiment, the cleaning robot has a control unit. Preferably, a processor and a memory for digital information is provided. In particular, the control unit is configured such that it causes the cleaning robot to execute the commands on the basis of commands that can be stored on the memory, for example.

### LIST OF REFERENCE SIGNS

1 cleaning robot

2 Sensor for detecting obstacles

3 Sensor for mapping the surroundings

4 brushes

5 direction of travel

6 cover

7 battery

8 wheels

9 surface to be cleaned

10 front side

11 first element of the cleaning mechanism

12 second element of the cleaning mechanism

13 third element of the cleaning mechanism

14 motor

15 interface

16 upper side

1. Method for cleaning a surface in a private household with a cleaning robot comprising the steps:
at least one of, by at least one sensor of the cleaning robot, detecting obstacles, mapping the surroundings, and performing a cleaning ride according to a route planned on the basis of sensor signals of the sensor;
supplying with electrical energy, by means of at least one battery of the cleaning robot, at least one motor that drives wheels for moving in a direction of travel and a cleaning mechanism for cleaning;
the cleaning robot having an overall height H of 0.12 m to 0.5 m;
the cleaning robot having a weight W of less than 20 kg;
the cleaning robot having a maximum possible operating speed Sₘₐₓ of less than 1.50 km/h;
the cleaning robot having an area performance A of 220 m² to 950 m² at DPU (Dust Pick-Up) >50%, wherein the area performance A=vₘₐₓ·S_{B} T 3600, where vₘₐₓ=maximum speed in [m/s] at DPU >50%, s_{B}=cleaning width of the cleaning robot in [m] and T=maximum running time in [h] at the maximum speed vₘₐₓ at DPU >50%, wherein the cleaning width s_{B} is the width transverse to the direction of travel, which the cleaning robot is capable of cleaning during a forward movement in the direction of travel during a cleaning ride;
the method further comprising the step of cleaning the surface, by the cleaning robot, at least twice a day for at least one week, wherein at least one piece of furniture with a clearance height of not more than 10 cm is present on the surface to be cleaned.

2. Method according to claim 1, characterized in that the total energy content E of the one battery or the plurality of batteries is in total at least 100 Wh or at most 200 Wh.

3. Method according to claim 1, characterized in that the cleaning robot is supplied with electrical energy by exactly two batteries.

4. Cleaning robot comprising:
at least one sensor for at least one of detecting obstacles , mapping the surroundings, and performing a cleaning ride according to a route planned on the basis of sensor signals of the sensor;
wheels for moving in a direction of travel and a cleaning mechanism for cleaning, wherein the wheels and the cleaning mechanism are driven by at least one motor which is supplied with electrical energy by means of at least one battery of the cleaning robot ;
the cleaning robot having an overall height of 0.12 m to 0.5 m;
the cleaning robot having a weight W of less than 20 kg;
the cleaning robot having a maximum possible operating speed of less than 1.50 km/h;
the cleaning robot having an area performance A of 220 m² to 950 m² at DPU >50%, wherein the area performance A=vₘₐₓ·S_{B} T 3600 and vₘₐₓ=maximum speed in [m/s] at DPU >50%, s_{B}=cleaning width of the cleaning robot (1) in [m] and T=maximum running time in [h] at the maximum speed vₘₐₓ at DPU >50%, wherein the cleaning width s_{B} is the width transverse to the direction of travel, which the cleaning robot is capable of cleaning during a forward movement in the direction of travel during a cleaning ride.

5. Cleaning robot according to claim 4, characterized in that the weight W is between 5 and 18 kg.

6. Cleaning robot according to claim 4, characterized in that its construction volume BV is greater than 11 L and less than 40 L.

7. Cleaning robot according to claim 4, characterized in that the cleaning width s_{B} is at least 25 cm and at most 35 cm.

8. Cleaning robot according to claim 5, characterized in that the maximum speed vₘₐₓ at DPU >50% is at least 0.3 m/s.

9. Cleaning robot according to claim 4, characterized in that the fiber pickup F is at least 80%.

10. Cleaning robot according to claim 4, characterized in that the coarse material pickup G is 100%.

11. Cleaning robot according to claim 8, characterized in that the maximum running time T at DPU >50% is at least 80 minutes.

12. Cleaning robot according to claim 4, characterized in that the cleaning robot has a D-shape when viewed from above.

13. Cleaning robot according to claim 4, characterized in that the cleaning robot comprises an interface for wireless data transmission.

14. Cleaning robot comprising:
at least one sensor for at least one of detecting obstacles, mapping the surroundings, and performing a cleaning ride according to a route planned on the basis of sensor signals of the sensor;
wheels for moving in a direction of travel and a cleaning mechanism for cleaning, wherein the wheels and the cleaning mechanism are driven by at least one motor which is supplied with electrical energy by means of at least one battery of the cleaning robot
the cleaning robot having a weight W of less than 20 kg;
the cleaning robot having a maximum possible operating speed of less than 1.50 km/h;
wherein the cleaning robot has a quality factor Q of at least 1.3 m²/Wh, wherein
$$Q = \frac{A}{E} \cdot R ,$$
with energy content E in [Wh] of the cleaning robot to achieve area performance A, a cleaning quality
$$R = \frac{D P U}{100 \%} \cdot \frac{F}{100 \%} \cdot \frac{G}{100 \%}$$
as the product or DPU in [%], a fiber pickup F in [%] and a coarse material pickup G in [%], and an area performance A at DPU >50%, for which applies: A=vₘₐₓ s_{B} T 3600, where vₘₐₓ =maximum speed in [m/s] at DPU >50%, s_{B}=cleaning width of the cleaning robot (1) in [m] and T=maximum running time in [h] at the maximum speed vₘₐₓ at DPU >50%, wherein the cleaning width is the width transverse to the direction of travel, which the cleaning robot is capable of cleaning during a forward movement in the direction of travel during a cleaning ride.

15. Cleaning robot according to claim 14, wherein a configuration characteristic K defined by the formula
$$K = \frac{H}{V} \cdot Q$$
has a value K of at least 180 Wh⁻¹, with an overall height H and a dust container volume V in [m³], wherein
$$Q = \frac{A}{E} \cdot R$$
witn an energy content E[Wh] of the at least one battery (7) of the cleaning robot, a cleaning quality
$$R = \frac{D P U}{100 \%} \cdot \frac{F}{100 \%} \cdot \frac{G}{100 \%}$$
as the product of DPU in [%], a fiber pickup F in [%] and a coarse material pickup G in [%] and an area performance A at DPU >50%, for which applies: A=vₘₐₓ s_{B} T 3600, with vₘₐₓ=maximum speed in [m/s] at DPU >50%, s_{B}=cleaning width of the cleaning robot in [m] and T=maximum running time in [h] at the maximum speed vₘₐₓ at DPU >50%.

16. Cleaning robot according to claim 14, characterized in that the cleaning robot has a D-shape when viewed from above.

17. Cleaning robot according to claim 14, characterized in that the cleaning robot comprises an interface for wireless data transmission.

18. Cleaning robot according to claim 14, characterized in that the weight W is between 5 and 18 kg.

19. Cleaning robot according to claim 18, characterized in that the maximum speed vₘₐₓ at DPU >50% is at least 0.3 m/s.

20. Cleaning robot according to claim 19, characterized in that the maximum running time T at DPU >50% is at least 80 minutes.
